(19) United States
(12) Patent Application Publication
(10) Pub. No.: US 2009/0301824 A1
(43) Pub. Date: Dec. 10, 2009

(54) Electromotive Actuator for a Parking Brake

(75) Inventors: Stefan Dettenberger, Ansbach (DE); Wilhelm Wolf, Petersaurach (DE)

Correspondence Address: MACMILLAN SOBANSKI & TODD, LLC, ONE MARITIME PLAZA FIFTH FLOOR, 720 WATER STREET, TOLEDO, OH, 43604-1619, US

(73) Assignee: OECHSLER AKTIENGESELLSCHAFT, Ansbach (DE)

(21) Appl. No.: 12/282,562

(22) PCT Filed: Mar. 12, 2007
(86) PCT No.: PCT/EP2007/002132

§ 371 Date: Feb. 27, 2009

(30) Foreign Application Priority Data
Mar. 14, 2006 (DE) 10 2006 011 928.2

(51) Int. Cl. F16D 65/21

(52) U.S. Cl. 188/158

(57) ABSTRACT

Disclosed is an actuator (11) for electromotively actuating the braking mechanism (22) of a parking brake, especially in a motor vehicle. In order to operate said actuator at low noise even at a high motor speed, the motor (12) of said actuator (11) is provided with a speed reducing element comprising a pinion that preferably has only two teeth and permanently engages with the helical teeth (18) of an intermediate gear (19) as a result of the ribbed shape of the teeth of the pinion, which wind around the pinion shaft (16). The intermediate gear (19), along with a spur toothed pinion (20), directly drives an output gear (21) encompassing the output shaft (14) of the actuator.

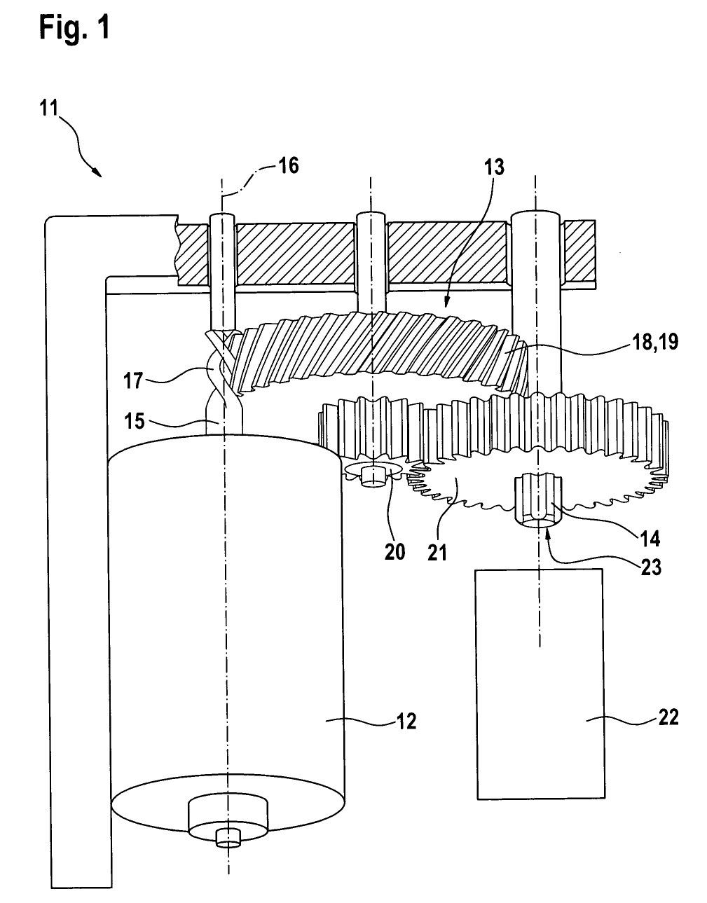

The invention relates to an actuator according to the preamble of claim 1.

For an actuator with a gear mechanism which can be driven by electric motor and has the purpose of activating what is referred to as the electric parking brake of a motor vehicle, it is preferable to aim at the highly speed-reducing gear mechanism in order to be able to use high-speed electric motors with small dimensions and a correspondingly small torque. DE 197 48 318 C1 discloses for this purpose a two-stage gear train in which the first gear stage is provided as a toothed belt transmission between the motor and a second gear stage in the form of an extreme and a highly speed-reducing, self-locking harmonic drives or wobble gear mechanism for reducing the output torque to a corresponding degree upstream of the actuator output. Each belt drive constitutes a flexible structure-borne sound coupling and therefore brings about a certain amount of decoupling from the vibrations originating from the motor. As a rotational-speed reduction gear stage which is arranged upstream of the actual speed-reducing gear mechanism, the belt drive has mainly a highly noise-reducing effect because the disruptive generation of noise depends essentially on the input speed of the output-end gear mechanism. The belt drive is also advantageous in being a gear stage which is arranged upstream because the axles of the motor and of the gear mechanism can then be arranged parallel to one another, which provides an overall compact design.

The input speed reduction which the belt drive brings about between the motor and the actual output-end highly speed-reducing gear mechanism is, however, limited for structural reasons, especially in terms of the minimum possible diameter of the smaller of the two belt pulleys which is supported by the motor output shaft. As has become apparent, this always causes noise to be generated in the input stage of the speed-reducing gear mechanism, which noise is hardly acceptable, at any rate in a passenger car, and certainly not in one with a higher equipment class. Furthermore, the increase in torque through greatly reducing the rotational speed provides extreme mechanical loading and therefore requires costly special structures using expensive injection molded plastics for the actuator, since said plastics can be loaded to a high level.

Particularly the latter also relates to the genus-defining electromotive brake actuator which is known from DE 103 49 078 A1. In said document the intention is to achieve smooth running by using the helical toothings which are generally known for this, applied over all successive stages of a multi-stage spur gear mechanism with approximately the same speed-reducing conditions in the successive gear stages. However, this solution requires considerable additional structural measures in order to reliably absorb the axial forces, caused by the helical toothing interventions and offset radially with respect to one another, in assigned bearing housings. Also, despite the helical toothings, relatively intense transmission of structure-borne sound still occurs in comparison with the belt drive owing to the alternating toothing interventions with relatively low speed reduction even in the input stage.

In view of these facts, the present invention is based on the technical problem of specifying an actuator of the generic type which, even given the more compact design which is aimed at, leads to a more cost-effective structure with, above all, much quieter operation.

This object is achieved according to the invention by means of the combination of the essential features specified in the main claim. Accordingly, an extremely high reduction of the rotational speed is already achieved in the first stage directly downstream of the engine in order to increase the torque, and also in order to reduce the axle spacing between the output shafts of the motor and of the actuator, which shafts are parallel to one another. This can be implemented with a low-stage spur gear mechanism which is produced by means of plastic injection molding using the evolvent toothing for the motor pinion, proven per se in machine engineering for the largest possible intermediate gear, within the scope of the available installation space, but before the actuator output. So that, for the sake of the desired only small level of generation of noise, the first toothing engagement of the gear mechanism chain provides as directly as possible the large reduction in rotational speed which is necessary for this, the motor pinion is equipped with an extremely small number of teeth, specifically with only one to five teeth, and the intermediate gear which intermeshes with them is typically provided with approximately at least 50 times the number of teeth as said pinion. The pinion teeth which permit an enlarged tooth modulus owing to their extremely small number are offset with respect to one another by the uniformly divided pinion circumference; and with preferably only two pinion teeth they are therefore diametrically opposite one another.

However, the aimed-at reduction in noise would be undermined if, because of the extremely low number of teeth of the pinion, engagement impacts were to occur in the spur toothing of the intermediate gear following it on the motor output side. For this reason, it is ensured that despite the extremely small number of the pinion toothing, said pinion toothing does not disengage from the spur toothing of the intermediate gear in any rotary position. This is achieved by virtue of the fact that each of the small number of teeth is in principle embodied as a radial longitudinal rib which extends in the axial direction on an outer lateral surface of a cylinder, but in such a case the respective rib winds, in its axial course on the lateral surface, winds around the pinion axis by at least the circumferential angle of the circumferential pitch of the cylinder cross section, that is to say by at least half the circumference of the pinion when there are two teeth. With helical spur toothing the intermediate gear is therefore always in a load-bearing engagement with at least one of the ribs which extend wound in this way, that is to say with at least one of the preferably two pinion teeth, as a result of which acoustically disruptive and structurally damaging impacts arising from the toothing engagement are reliably avoided. These teeth which are embodied for example as wound ribs can be provided on a cylinder on the motor output shaft which serves as a pinion, but said motor output shaft can also be constructed directly with such a wound rib structure. The decisive factor is that here there is not, for example, a worm drive (with its rotational axes orthogonal to one another) but rather helical spur toothing (with parallel axes) having classical evolvent geometry of the tooth cross sections which have come into engagement with one another as is treated theoretically in, for example, the specialist book MASCHINENELEMENTE [Machine Elements] (G. Niemann, H. Winter; Springer-Verlag 1985) in section 22.5.3b of volume II.

At first, the correspondingly helically toothed intermediate gear is preferably itself not yet provided with the actuator output shaft but rather, for the purpose of further reduction of the rotational speed, drives, with a pinion with straight spur toothing, an output gear with speed reduction of typically 2:1, which then itself only has a profiled shaft end as the actuator output shaft. For the sake of low axial loading, this second gear stage is then provided with straight spur toothing, which is then no longer disruptive in terms of the generation of noise because the input speed of the gear mechanism has already been decisively reduced here.

For the sake of undisrupted transmission of torque despite the small diameter when injection molding materials are used which are economic since they are not high-strength, the output shaft is not equipped at its free front end with a conventional toothing geometry or with a groove/tongue connection but rather has a profile with a clover-leaf-shaped engagement cross section with indents which extend in an oval shape for connecting, for example, a brake mechanism. There is therefore no need any more for structural complexity and for the additional individual parts made of expensive high-strength materials in view of the axial loading and the installation space for a highly speed-reducing mechanism on the output side, in the manner in particular of a harmonic drive, of a wobble gear mechanism or of a planetary gear mechanism with multiple cascades, for speed reduction of the order of magnitude of 100:1, since an additional noise generator has been dispensed with.

The inventive solution is also based on the realization that the decoupling of the structure-borne sound from the motor by means of a belt drive upstream of a highly speed-reducing gear mechanism contributes significantly less to the aimed at quiet operation than a large reduction in rotational speed as far as possible directly downstream of the actuator motor, and therefore without the additional multi-stage speed-reducing gear mechanism on the output side.

According to the invention, the output rotational speed of the actuator for electromotively activating the parking brake, in particular in a passenger car, is therefore reduced directly at the actuator motor by means of a single-stage reduction in the rotational speed which is of such a magnitude that a rotational speed occurs here which is uncritical in terms of noise, for which reason a single-tooth to five-tooth pinion is provided on the motor output side. Despite this extremely small number of teeth, said pinion remains, by virtue of the wound, rib-shaped profile of the teeth, continuously in engagement with the helical spur toothing of an intermediate gear with axes parallel to the latter, which intermediate gear itself preferably acts with a spur-toothed pinion via an output gear on the actuator output shaft in order to output the torque for activating a brake mechanism.

In order to explain in more detail the solution according to the invention, a preferred exemplary embodiment which is outlined in the drawing will be described below. The single figure of the drawing shows, approximately true to scale, an oblique view of the assembly of an electromotive actuator for activating a vehicle brake mechanism.

The electromotive actuator 11 with small dimensions has a drive motor 12 with rotational speed-reducing spur gear mechanism 13 which is connected downstream and is upstream of an actuator output shaft 14. The motor shaft 15 is embodied directly as a pinion with only an extremely small number (two here) of teeth in the form of longitudinal ribs 17 (both are diametrically opposite one another here) which wind around the axis 16. Said longitudinal ribs 17 engage in the helical toothing 18 of an intermediate gear 19 in order to reduce the speed with an order of magnitude of at least 50:1. Its pinion 20, with straight toothing, intermeshes for an additional reduction of the rotational speed of 2:1 with an output gear 21 which also has straight toothing. A shaft end which projects coaxially from the latter is profiled to form the output shaft 14 in order to be able to couple it to the brake mechanism 22 in a rotationally fixed fashion. For this purpose, the output shaft 14 has, for the sake of large torque loadability despite a small cross section, an approximately clover-leaf-shaped engagement cross section 23 with indents which extend in an oval shape.

### LIST OF REFERENCE NUMERALS

11 Actuator (with 12 and 13)
12 Motor
13 Gearbox (between 12 and 14)
14 Output shaft (of 11/13 at 21)
15 Motor shaft (of 12)
16 Axis (of 15)
17 Longitudinal ribs (on 16)
18 Helical toothing (of 19, in 17)
19 Intermediate gear (with 18)
20 Pinion (of 19)
21 Output gear (downstream of 20)
22 Brake mechanism (downstream of 11)
23 Input cross section (of 14 for 22)

1. A motor vehicle parking brake having an electromotive actuator with a motor and a helically toothed gear mechanism which is arranged downstream of the motor and upstream of an actuator output shaft, wherein the gear mechanism has an intermediate gear with helical toothing which is in engagement with a motor pinion provided with a small number of teeth in the form of longitudinal ribs which extend wound around a motor pinion axis offset with respect to one another with a uniform circumferential pitch, with each longitudinal rib winding in accordance with one of these pitches at least by a circumferential angle, wherein the intermediate gear is equipped with a pinion which is in spur-toothed engagement with an output gear which has the actuator output shaft.

2. The parking brake as claimed in claim 1, wherein the longitudinal ribs are formed on an output shaft of the motor.

3. The parking brake as claimed in claim 1, wherein the longitudinal ribs are provided on a cylinder of the output shaft of the motor.

4. The parking brake as claimed in, claim 1, wherein only two longitudinal ribs which extend in a wound fashion are provided diametrically opposite one another.

5. The parking brake as claimed in claim 1, wherein the helical toothing of the intermediate gear and the longitudinal ribs have evolvent cross-sectional geometries.

6. The parking brake as claimed in claim 1, wherein the actuator output shaft is equipped, at a free spur end, with an engagement cross section which has a clover-leaf-like profile with indents which extend in an oval shape.

7. The parking brake as claimed in claim 1, wherein the motor pinion is provided with not more than two teeth.
